(19) United States
(12) Patent Application Publication
(10) Pub. No.: US 2026/0371364 A1
(43) Pub. Date: Nov. 19, 2026

(54) SIDELINK SYNCHRONIZATION SIGNAL BLOCK TRANSMISSION IN FR2 BEAM MANAGMENT

(71) Applicant: Apple Inc., Cupertino, CA (US)

(72) Inventors: Huaning Niu, San Jose, CA (US); Chunxuan Ye, San Diego, CA (US); Wei Zeng, Saratoga, CA (US); Haitong Sun, Cupertino, CA (US); Sayed Ali Akbar Fakoorian, San Diego, CA (US); Dawei Zhang, Saratoga, CA (US); Hong He, San Jose, CA (US)

(21) Appl. No.: 19/148,052

(22) PCT Filed: Jan. 22, 2024
(86) PCT No.: PCT/US24/12317

§ 371 Date: Jul. 15, 2025

Related U.S. Application Data
(60) Provisional application No. 63/484,374, filed on Feb. 10, 2023.

(51) Int. Cl. H04W 72/25; H04L 27/26

(52) U.S. Cl. CPC H04W 72/25; H04L 27/261

(57) ABSTRACT

Systems, methods, and circuitries are provided for generating sidelink synchronization signal blocks (S-SSB) that identify a transmit UE. In one example, a method includes generating an S-SSB that encodes a synchronization source identifier (SSID) for frequency range 2 (FR2) based on a UE identifier (ID) and transmitting the S-SSB to a receiving UE.

### CROSS REFERENCE TO RELATED APPLICATIONS

This application claims the benefit of priority from U.S. Provisional Patent Application Ser. No. 63/484,374 filed on Feb. 10, 2023, the contents of which are hereby incorporated by reference in their entirety.

### BACKGROUND

The present disclosure relates generally to wireless communication and more specifically to techniques for performing sidelink or device-to-device communication in a radio network.

### BRIEF DESCRIPTION OF THE DRAWINGS

Some examples of circuits, apparatuses and/or methods will be described in the following by way of example only. In this context, reference will be made to the accompanying figures.

FIG. 1 is a diagram of an example of a Uu link beam selection and refinement process between a radio access network (RAN) node and a user equipment (UE), in accordance with various aspects described.

FIG. 2 is a diagram of an example of a sidelink beam selection and refinement process between two UEs, in accordance with various aspects described.

FIG. 3 is illustrates a legacy sidelink synchronization signal block (S-SSB).

FIG. 4 is a functional block diagram of a sidelink communication network that employs legacy S-SSB.

FIG. 5 illustrates a sidelink synchronization signal block (S-SSB) that includes a synchronization source identifier (SSID) for frequency range 2 (FR2) (SSID-FR2), in accordance with various aspects described.

FIG. 6 is a functional block diagram of a sidelink communication network that synchronizes based on S-SSBs that include SSID-FR2, in accordance with various aspects described.

FIG. 7 illustrates an S-SSB that includes an SSID-FR2, in accordance with various aspects described.

FIG. 8 is a functional block diagram of a sidelink communication network that synchronizes based on S-SSBs that include SSID-FR2, in accordance with various aspects described.

FIG. 9 illustrates an S-SSB that includes an SSID-FR2, in accordance with various aspects described.

FIG. 10 is a functional block diagram of a sidelink communication network that synchronizes based on S-SSBs that include SSID-FR2, in accordance with various aspects described.

FIG. 11 illustrates an S-SSB that includes an SSID and additional UE ID bits, in accordance with various aspects described.

FIG. 12 is a functional block diagram of a sidelink communication network that synchronizes based on S-SSBs that include an SSID and additional UE ID bits, in accordance with various aspects described.

FIG. 13 illustrates an S-SSB that includes an SSID-FR2, in accordance with various aspects described.

FIG. 14 is a functional block diagram of a sidelink communication network that synchronizes based on S-SSBs that include SSID-FR2, in accordance with various aspects described.

FIG. 15 illustrates an S-SSB that includes an SSID and additional UE ID bits, in accordance with various aspects described.

FIG. 16 is a functional block diagram of a sidelink communication network that synchronizes based on S-SSBs that include an SSID and additional UE ID bits, in accordance with various aspects described.

FIG. 17 is a flow diagram outlining a method for performing sidelink synchronization and beamforming, in accordance with various aspects described.

FIG. 18 is a flow diagram outlining a method for performing sidelink synchronization and beamforming, in accordance with various aspects described.

FIG. 19 is a flow diagram outlining a method for performing sidelink synchronization and beamforming, in accordance with various aspects described.

FIG. 20 is a flow diagram outlining a method for performing sidelink synchronization and beamforming, in accordance with various aspects described.

FIG. 21 is a functional block diagram of a wireless communication network, in accordance with various aspects described.

FIG. 22 illustrates a simplified block diagram of a user equipment device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration.

Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

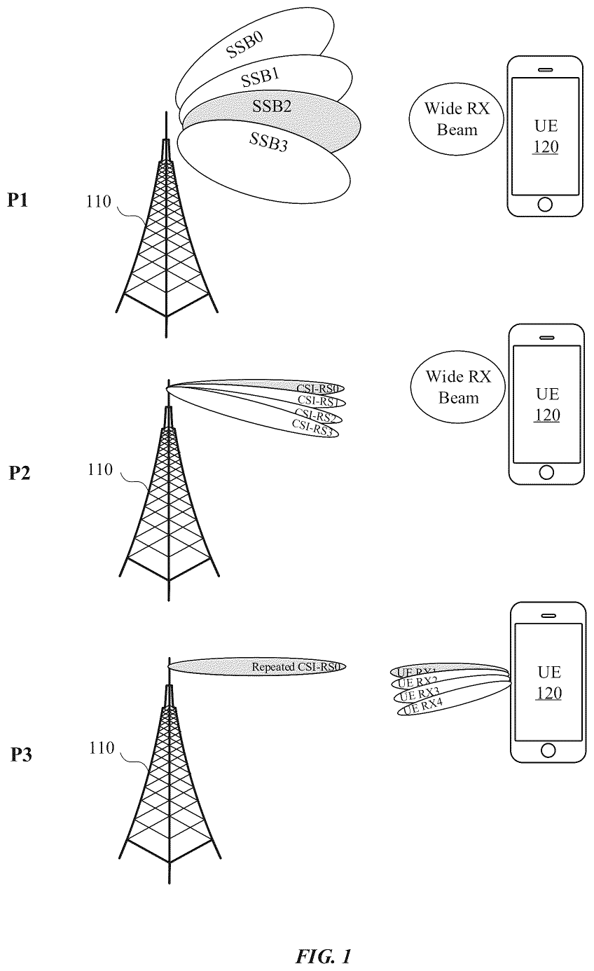

Beamforming is an important aspect of new radio (NR) communication in high frequency bands (e.g., frequency range 2 (FR2). Maintaining a high quality Uu link beam with a mobile user involves a significant amount of overhead signaling. FIG. 1 illustrates a three step beam management process that is employed to maintain the Uu link. Process P1 is used to select an optimal wide beam. A base station 110 transmits respective synchronization signal blocks (SSBs) using different wide transmit beams. The SSBs are transmitted sequentially in time (i.e., wide beam sweeping) with preconfigured offset between SSBs. A UE 120 receives the SSBs using a wide receive (RX) beam, and may sweep wide RX beams during the P1 process. Each SSB includes a primary synchronization signal (PSS) that encodes a physical layer cell identity (PCI) for the base station. The UE identifies the SSB that was optimally received and reports the “optimal” or “best” wide beam (as identified by an associated SSB resource indicator (SSBRI)) to the base station. Factors that a UE may use in selecting the optimal beam include the relative signal-to-noise ratios (SNRs) of the received SSBs. During wide or narrow beam selection, the comparison of the different beams may be made based on reference signal received power (RSRP) measurements made on reference signals (e.g., SSB or CSI-RS) associated with each beam. In the illustrated example, the UE 120 selects SSB2 as the optimal wide beam. In the illustrated example, the UE 120 selects SSB2 as the optimal wide beam.

P2 is a beam refinement process in which a narrower beam from within the selected wide beam is selected by the UE. The base station 110 sweeps narrower beams within the selected wide bean by sequentially transmitting respective channel state information reference signals (CSI-RS) on respective narrower beams that fall within the selected optimal wide beam. The UE reports the strongest narrower beam (as identified by an associated CSI-RS resource indicator (CRI)) to the base station. In the illustrated example, the selected narrow beam is associated (e.g., quasi co-located (QCLed) with CSI-RS 0.

The P1 wide beam selection and P2 transmitter narrow beam refinement processes are focused on the base station selecting an optimal transmit beam for a particular UE. In the P3 process, the UE selects an optimal narrow UE RX beam. After the base station receives the narrow beam selection from the UE, the base station repeatedly transmits CSI-RS (called “repeated CSI-RS” in this disclosure) on the selected narrow beam. The UE scans its narrow RX beams and selects the UE RX beam that optimally receives the CSI-RS. The UE 120 does not report its selected beam to the base station 110. The UE may sometimes trigger the base station to transmit a beam tracking reference signal (e.g., CSI-RS or repeated CSI-RS) to allow the UE to perform a subsequent UE beam refinement process as the UE moves or channel conditions change.

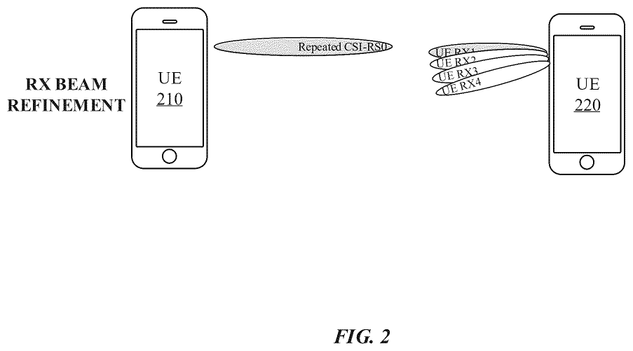

Beamforming in sidelink communication may utilize a similar beam selection and beam refinement process as outlined in FIG. 1 for the Uu link. However, there are some differences in sidelink communication and Uu link based communication that should be addressed to support sidelink beamforming. FIG. 2 illustrates an example sidelink beam selection/refinement process that is adapted from the P1, P2, P3 processes outlined in FIG. 1.

During a TX wide beam selection process, a transmitting (TX) UE 210 transmits S-SSBs. An RX UE 220 uses its wide RX beam to receive the S-SSBs and determine which S-SSB is optimally received. The RX UE 220 reports the optimal beam (e.g., as indicated by a sidelink SSBRI (S-SSBRI).

One challenge in adapting the beam selection process (P1) for the Uu link for use in selecting an optimal wide sidelink TX beam is that there are differences in the S-SSBs sent by UEs for sidelink communication as compared to the SSBs sent by base stations. To support sidelink communication, UEs transmit sidelink SSBs (S-SSBs). The S-SSBs include an SSID that indicates a type and source of synchronization provided by the TX UE. For example, the SSID may indicate that the UE is directly synchronized to a particular base station, indirectly synchronized to a particular base station through a UE that is directly synchronized to the base station, synchronized to a global navigation satellite system (GNSS), and so on. This allows UEs that may be out of range of a base station to find a suitable UE from which to receive timing signals. In one aspect, sidelink communication may enabled for UEs having a same SSID, which means that they derive their synchronization from a same source (e.g., a same base station or UE) and UEs having different SSIDs may not be enabled for sidelink communication with each other.

The SSIDs are used to communicate the synchronization source and type of synchronization the UE provides, but do not indicate a unique identity of the UE. UE identifiers are not assigned until sidelink communication is configured between two UEs. During sidelink configuration a destination identifier is assigned to an RX UE and a source identifier is assigned to a TX UE (e.g., by an application layer) through sidelink control information (SCI). Thus, unlike the Uu link beam selection procedure in which the UE can determine the PCI from the SSB, a UE receiving S-SSB will not know the identity of the UE that is transmitting the S-SSB. This means that the SSID may not provide sufficient information for use in selecting sidelink beams.

Picking up with the sidelink beam selection process of FIG. 2, it is assumed that the S-SSB or other signaling allows the RX UE 220 to associate a given S-SSB with a particular TX UE. In response to the reporting of the optimal wide beam by the RX UE 220, during a TX narrow beam selection process the TX UE 210 transmits CSI-RS and the RX UE reports the optimal narrow beam (e.g., as indicated by a sidelink CRI (S-CRI). During an RX beam refinement process, the TX UE 210 transmits repeated CSI-RS on the selected narrow beam for use by the RX UE 220 in selecting its optimal RX beam.

### Legacy Sidelink SSB

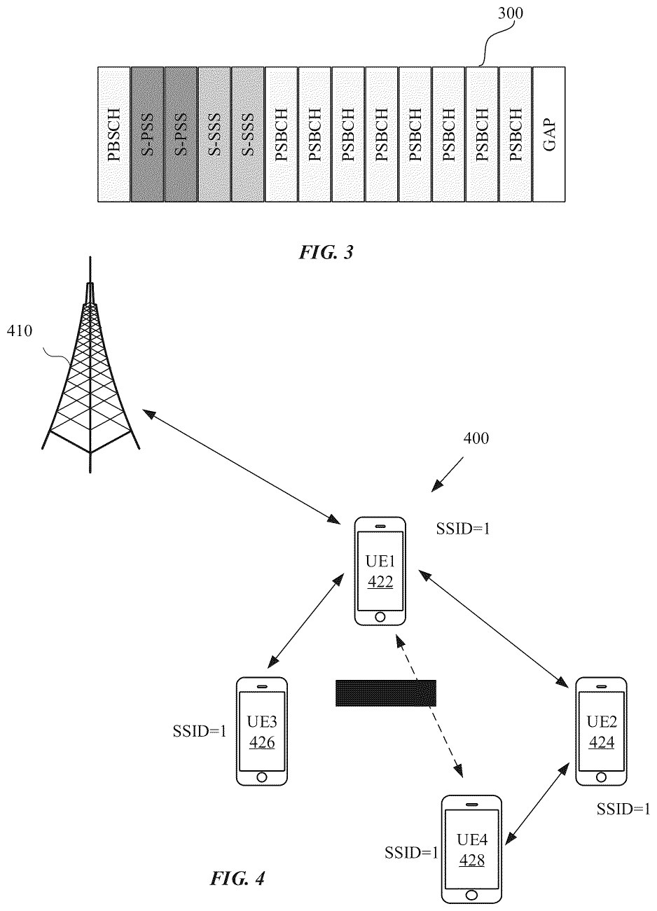

FIG. 3 illustrates an exemplary S-SSB 300. Each block represents a symbol and the S-SSB has a length in the time dimension of a slot. The S-SSB has the same numerology (e.g., subcarrier spacing (SCS)) as PSCCH/PSSCH. The time resource for the S-SSB is preconfigured in cell specific uplink resources in the Uu allocation. The periodicity of the S-SSB is 160 ms for all SCS, with the number of transmissions in one period being configurable. The interval between neighboring S-SSBs within a period is the same and this interval is a configurable parameter. The offset from the beginning of the period to the first S-SSB is also a configurable parameter. S-SSB repetition may also be configured.

As introduced above, an RX UE can derive an SSID from the S-SSB. Similar to downlink transmission in NR, in sidelink transmissions, primary and secondary synchronization signals called S-PSS and S-SSS are supported, in which M-sequence and Gold sequence are used to generate the S-PSS and the S-SSS, respectively. Through detecting the S-PSS and the S-SSS, the RX UE is able to identify the SSID of the TX UE. There are two S-PSS sequences {0, 1} and 336 S-SSS sequences {0, . . . , 335}. The SSID is calculated as S-SSS+336*S-PSS to generate 672 SSIDs.

As currently configured, an SSID value of 0 indicates that the TX UE is directly synched to GNSS, an SSID value of 336 or 337 indicates that the TX UE is synched indirectly to GNSS. An SSID value in {1, . . . , 335} indicates that the TX UE is in coverage or synched directly or indirectly to the base station. An SSID in {336, . . . , 671} indicates that the TX UE is out of coverage and synched directly to another out of coverage UE. Through detecting the S-PSS/S-SSS the RX UE is able to know the characteristics of the TX UE for timing and frequency synchronization purposes. In some aspects, sidelink communication is only enabled between UEs that have the same SSID, which indicates that the UEs are synched to a same source (e.g., the same base station or the same out of coverage UE). While the SSID identifies a synchronization source of a UE, the SSID does not uniquely identify the UE for beamforming purposes.

The physical sidelink broadcast channel (PSBCH) is also transmitted in the S-SSB. The PSBCH conveys information related to synchronization such as direct frame number (DFN) indication of the slot and symbol level time resources for sidelink transmissions, a slot index which may be used to derive a mapping beam index, and so on. The PSBCH also carries a demodulation reference signal (DMRS).

FIG. 4 illustrates a wireless communication network 400 in which four UEs 422, 424, 426, 428 are configured for sidelink communication as synchronized based on a base station 410. UE 422 is in coverage and directly synched to base station 410 acquires SSID=1. UEs 424 and 426 are also synched to the base station 410 although indirectly through UE 422. UEs 424 and 426 acquire the same SSID=1. UE 428 is synched to the base station 410 through a two-hop indirect synchronization using UE 424 and UE 422. UE 428 acquires the same SSID=1. As described above, as currently configured, sidelink communication is enabled between the UEs 422, 424, 426, 428 based on the UEs having a same SSID.

As illustrated in FIG. 4, a beam from UE 422 is directed toward UE 428 but is obstructed while a beam from UE 424 may be better received by UE 428. However, UE 428 would not be able to determine which UE (e.g., 422 or 424) transmitted any S-SSBs that are received. This means that the S-SSBs, as currently configured, do not convey sufficient information to support beamforming.

### S-SSB Design for Beam Management

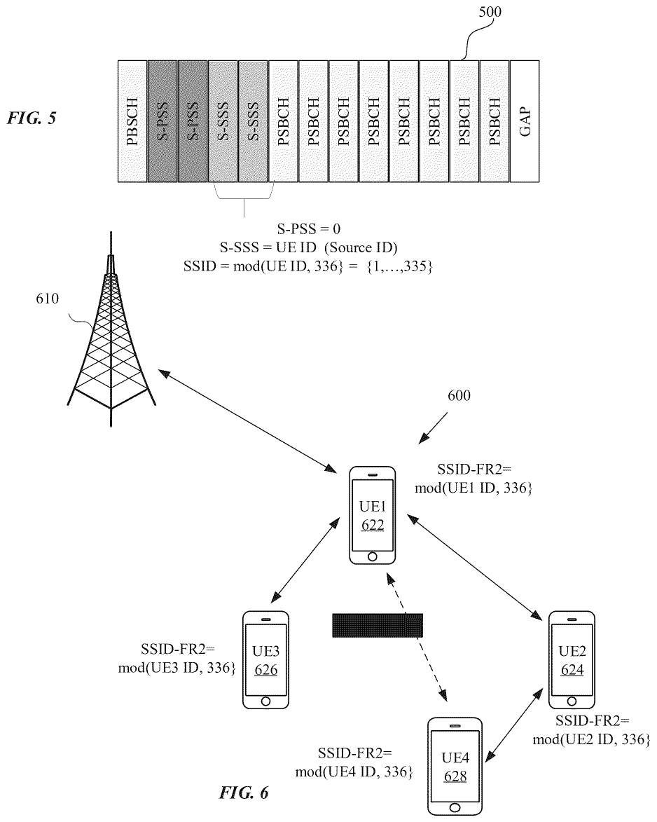

A modified SSID that indicates a particular UE ID to support beamforming in frequency range 2 (FR2) is referred to herein as an SSID-FR2. FIGS. 5 and 6 illustrate an example of a first S-SSB design that supports beamforming by encoding a different SSID-FR2 ranging from {1, . . . , 335} to each UE that is in coverage and synched directly or indirectly to a base station. As shown in S-SSB 500 of FIG. 5, the SSID-FR2 are encoded by an S-PSS value of 0 and an S-SSS value between 1 and 335 that encodes a UE ID. In one example, the SSID-FR2 encodes a source ID for the UE. The source ID for the UE may be configured by a higher layer, such as an application layer. The source ID has 8 bits, so the source ID may have 256 different values, which can be encoded in the bits currently allocated for the S-SSS. The source ID and the SSID-FR2 may be linked so that source ID=mod(SSID-FR2, 256). This may enable the same source ID to be assigned to the same UE by different applications, which is desirable since UE antenna panels may be shared.

In another example each UE that is in coverage and synched directly or indirectly to a base station is assigned an SSID-FR2 ranging from {1, . . . , 335} by the network. The SSID-FR2 for a UE may be forwarded by intervening SL UEs if necessary. This approach may avoid collisions caused by two UEs having a same UE ID (e.g., due to source IDs being assigned by different applications).

In another example, the SSID-FR2 is derived from a serving temporary mobile subscriber identity (s-TMSI) for the UE. In this case, SSID-FR2 may be derived as IMSI mod 336 to generate a value between {1, . . . , 335}. IMSI should be used in decimal form and is stored in the universal subscriber module (USIM) of the UE.

In other examples, other types of UE IDs may be used to generate the SSID-FR2, including destination ID, UE ID used in the media access control (MAC) layer, and so on.

For these example SSID-FR2 derivation techniques, all UEs that are in coverage and synched directly or indirectly to a base station are each assigned an SSID-FR2 ranging from {1, . . . , 335} based on an identifier for the UE (e.g., source ID, network assigned ID, IMSI). Thus, as shown in FIG. 6, each of the UEs 622, 624, 626, 628 has a unique SSID as indicated. To enable sidelink communication between UEs that are in coverage with direct or indirect synchronization to a base station, rules that limit sidelink communication to UEs with a same SSID should be relaxed to allow sidelink communication between UEs having an SSID-FR2 between 1 and 335, after SSB acquisition. This relaxation is appropriate because FR2 networks are synchronous, and thus a UE that is synched to any base station will by definition be synched to another UE that is itself synched to a different base station.

For beamforming purposes, with the SSID-FR2 an RX UE can distinguish between S-SSBs sent by different beamforming TX UEs and can determine a beam associated with each S-SSB based on a slot index that is signaled in the PSBCH.

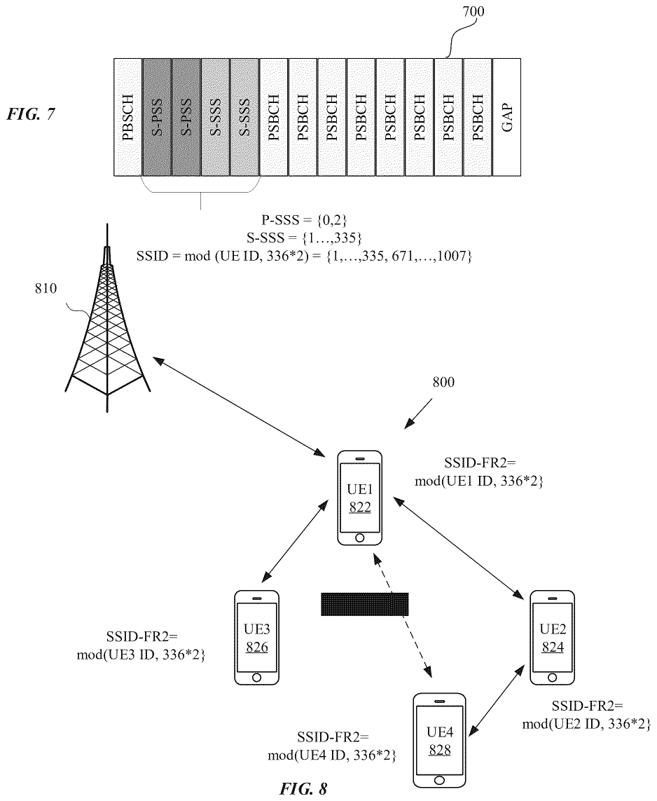

FIGS. 7 and 8 illustrate an example of an alternative technique for generating SSIDs in a manner that supports a higher number of unique SSID-FR2, to avoid collisions that may be caused by the relatively small number of unique identifiers allowed by the 8 bits in the source ID. As shown by S-SSB 700 in FIG. 7, assuming that S-SSS may encode a value between 1 and 335, the S-PSS value is enabled to be set to 2. This enables SSID-FR2={671, . . . , 1007} (with S-PSS=2) in addition to SSID-FR2={1, . . . , 335} (with S-PSS=0). In this option, one seed point may be added for generating the S-PSS. For example, the set of currently configured seed points can be expanded to include a seed point of 108, which yields the S-PSS value mapped to 2. This increase in SSID values allows for the SSID to be based on a UE ID corresponding to a higher bitwidth UE ID, such as the 16 bit destination ID. In this example, the SSID=mode (destination ID, 336*2).

For these example SSID-FR2 derivation techniques, all UEs that are in coverage and synched directly or indirectly to a base station are each assigned an SSID-FR2 ranging from {1, . . . , 335} and {671, . . . , 1007} based on an identifier for the UE (e.g., destination ID). Thus, as shown in FIG. 8, each of the UEs 822, 824, 826, 828 has a unique SSID as indicated. To enable sidelink communication between UEs that are in coverage with direct or indirect synchronization to a base station, rules that limit sidelink communication to UEs with a same SSID should be relaxed to allow sidelink communication between UEs having an SSID-FR2 within {1, . . . , 335, 671, . . . , 1007} after SSB acquisition. This relaxation is appropriate because FR2 networks are synchronous, and thus a UE that is synched to any base station will by definition be synched to another UE synched to a different base station.

For beamforming purposes, with the SSID-FR2 an RX UE can distinguish between S-SSBs sent by different beamforming TX UEs and can determine a beam associated with each S-SSB based on a slot index that is signaled in the PSBCH.

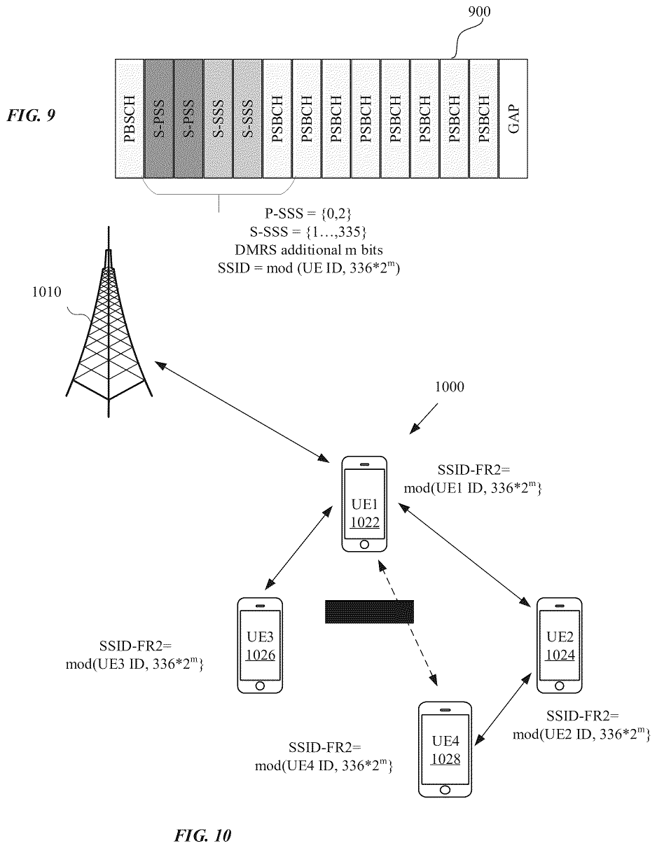

FIGS. 9 and 10 illustrate an example of an alternative technique for generating SSIDs in a manner that supports an even higher number of unique SSID-FR2, as compared to the examples of FIGS. 7 and 8. As shown by S-SSB 900 in FIG. 9, assuming that S-SSS may encode a value between 1 and 335, and S-PSS value is enabled to be set to 2, DMRS scrambling is adapted to encode m bits, which can be added to the UE ID SSID encoded by S-PSS and S-SSS to enable 2^{m}*336 unique SSID-FRS. The RX UE performs a DMRS hypothesis to decode the bits from the DMRS. For example, the initialization value Cinit for the DMRS may be equal to SSID-FR2*DMRS_idx, where DMRS_idx={1, . . . , 2^{m}}. This increase in SSID values allows for the SSID to be based on a UE ID corresponding to a higher bitwidth UE ID, such as the 16 bit destination ID. In this example, the SSID=mode (destination ID, 336*2^{m}). In one example, m is three.

For these example SSID-FR2 derivation techniques, all UEs that are in coverage and synched directly or indirectly to a base station are each assigned an SSID-FR2 ranging from {1, . . . , 335*2^{m}} based on an identifier for the UE (e.g., destination ID) as augmented by the DMRS bits. Thus, as shown in FIG. 10, each of the UEs 1022, 1024, 1026, 1028 has a unique SSID as indicated. To enable sidelink communication between UEs that are in coverage with direct or indirect synchronization to a base station, rules that limit sidelink communication to UEs with a same SSID should be relaxed to allow sidelink communication between UEs having a same SSID-FR2. This relaxation is appropriate because FR2 networks are synchronous, and thus a UE that is synched to any base station will by definition be synched to another UE synched to a different base station.

For beamforming purposes, with the SSID-FR2 an RX UE can distinguish between S-SSBs sent by different beamforming TX UEs and can determine a beam associated with each S-SSB based on a slot index that is signaled in the PSBCH.

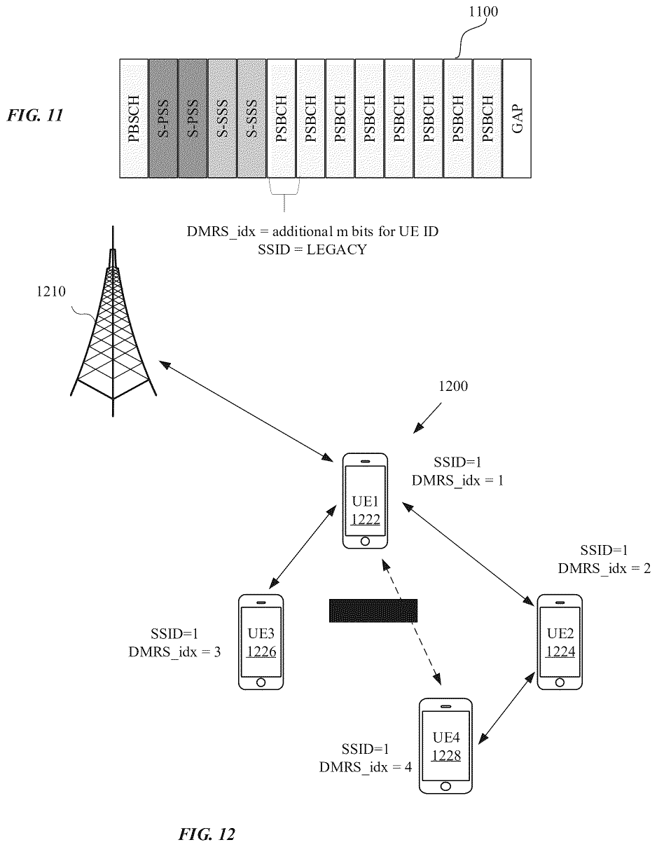

FIGS. 11 and 12 illustrate an example of an alternative technique for generating SSIDs in a manner that supports use of the legacy SSID, which is generated based on an identifier for a synchronization source for the UE. As shown by S-SSB 1100 in FIG. 11, DMRS scrambling encodes m bits, which can be used to encode a UE ID that can distinguish up to 2^{m} UEs having a same synchronization source. The RX UE performs a DMRS hypothesis to decode the bits from the DMRS. In one example, m is three, so that eight unique UE IDs may be encoded by the DMRS_idx. In this example, DMRS_idx=mod(source ID, 8). In this approach, the rules about sidelink communication being enabled only for UEs having a same SSID do not need to be relaxed.

As shown in FIG. 12, each UE 1222, 1224, 1226, 1226 is assigned the same SSID. For beamforming purposes, an RX UE can distinguish between S-SSBs sent by different beamforming TX UEs based on the DMRS_idx determined from the S-SSB and can determine a beam associated with each S-SSB based on a slot index that is signaled in the PSBCH.

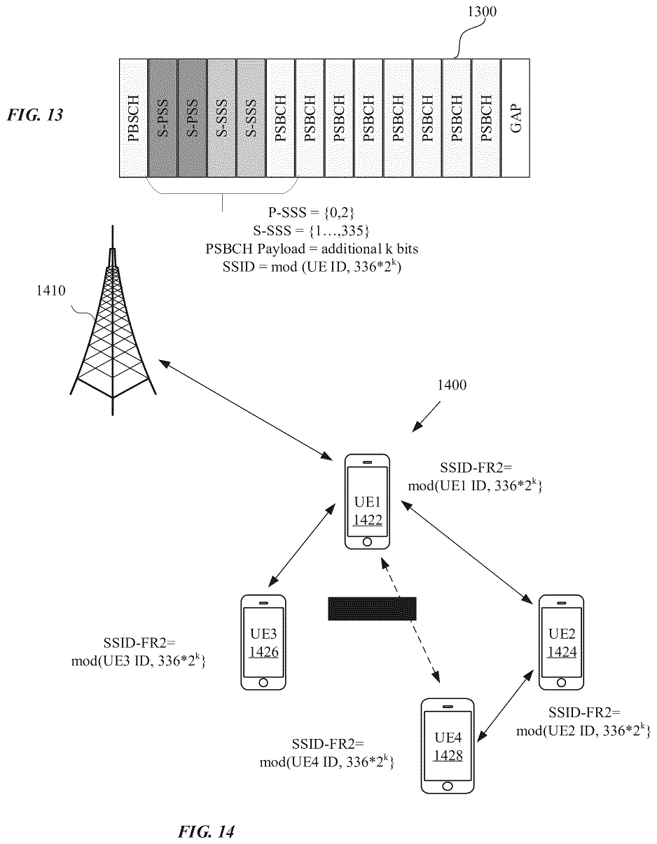

FIGS. 13 and 14 illustrate an example of an alternative technique for generating SSIDs in a manner that supports a higher number of unique SSID-FR2. As shown by S-SSB 1300 in FIG. 13, assuming that S-SSS may encode a value between 1 and 335, and S-PSS value is enabled to be set to 2, additional k bits in the PSBCH payload are combined with the UE ID based SSID encoded by S-PSS and S-SSS to enable 2^{k}*336 unique SSID-FRS. This increase in SSID values allows for the SSID to be based on a UE ID corresponding to a higher bitwidth UE ID, such as the 16 bit destination ID. In this example, the SSID=mode (destination ID, 336*2^{k}). In one example, k is two, with reserved bits in the PSBCH being used and/or a bit used in the PSBCH to indicate whether a UE is synched directly or indirectly to a base station is repurposed for use as part of the SSID-FR2.

For these example SSID-FR2 derivation techniques, all UEs that are in coverage and synched directly or indirectly to a base station are each assigned an SSID-FR2 ranging from {1, . . . , 335*2^{k}} based on an identifier for the UE (e.g., destination ID) as augmented by the PSBCH bits. Thus, as shown in FIG. 14, each of the UEs 1422, 1424, 1426, 1428 has a unique SSID as indicated. To enable sidelink communication between UEs that are in coverage with direct or indirect synchronization to a base station, rules that limit sidelink communication to UEs with a same SSID should be relaxed to allow sidelink communication between UEs having a same SSID-FR2 after SSB acquisition. This relaxation is appropriate because FR2 networks are synchronous, and thus a UE that is synched to any base station will by definition be synched to another UE synched to a different base station.

For beamforming purposes, with the SSID-FR2 an RX UE can distinguish between S-SSBs sent by different beamforming TX UEs and can determine a beam associated with each S-SSB based on a slot index that is signaled in the PSBCH.

The additional k bits carried by the PSBCH can be combined with the three additional bits encoded by the DMRS in the example illustrated in FIGS. 9 and 10 to further extend the number of unique UE IDs by a factor of 64.

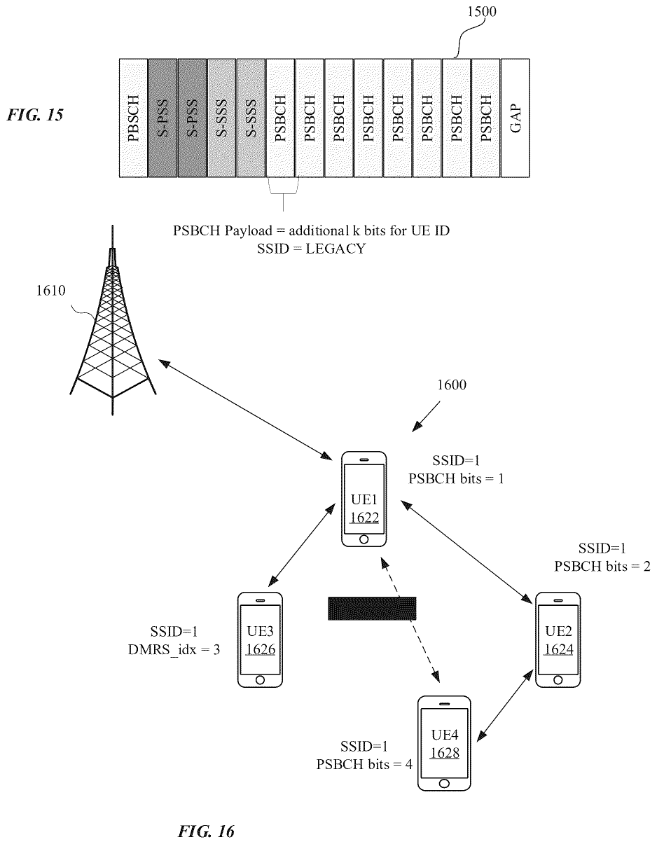

FIGS. 15 and 16 illustrate an example of an alternative technique for generating SSIDs in a manner that supports use of the legacy SSID, which is generated based on an identifier for a synchronization source for the UE. As shown by S-SSB 1500 in FIG. 15, the PSBCH payload encodes k bits, which can be used to encode a UE ID that can distinguish up to 2^{k} UEs having a same synchronization source. In one example, k is two, with reserved bits in the PSBCH being used and/or a bit used in the PSBCH to indicate whether a UE is synched directly or indirectly to a base station is repurposed for use as part of the UE ID. The additional k bits carried by the PSBCH can be combined with the three additional bits encoded by the DMRS in the example illustrated in FIGS. 11 and 12 to further extend the number of unique UE IDs by a factor of 64.

As shown in FIG. 16, each UE 1622, 1624, 1626, 1626 is assigned the same SSID. For beamforming purposes, an RX UE can distinguish between S-SSBs sent by different beamforming TX UEs based on the PSBCH bits and can determine a beam associated with each S-SSB based on a slot index that is signaled in the PSBCH.

Higher layer configuration may be used to select which of the disclosed techniques for encoding a UE ID in S-SSB are to be used. Higher layer encoding may be used to configure a source ID and/or destination ID for a UE based on an SSID-FR2.

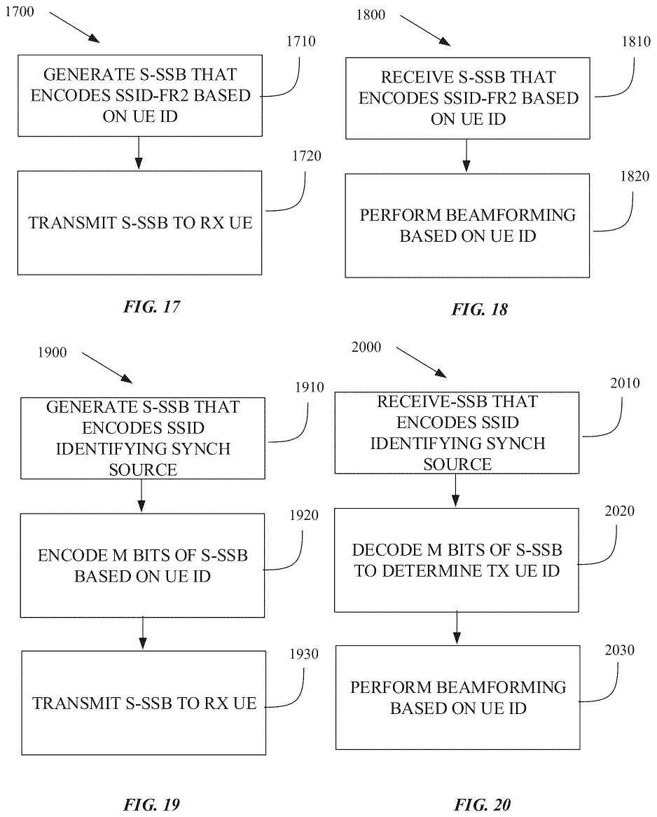

FIG. 17 is a flow diagram outlining a method 1700 for performing sidelink synchronization and beamforming. The method 1700 may be performed by any of the UEs of FIGS. 5, 7, 9, and 13. The method includes, at 1710 generating a sidelink synchronization signal block (S-SSB) that encodes a synchronization source identifier (SSID) for frequency range 2 (FR2) based on a UE identifier (ID). At 1720, the method includes transmitting the S-SSB to a receiving (RX) UE.

In one example, as illustrated in FIGS. 5, 7, 9, and 13, the SSID-FR2 is encoded based on a source identifier (ID) assigned to the UE by a higher layer. The source ID may be derived by the higher layer based on mod (SSID, 256). The SSID-FR2 value may be between 1 and 256 based on the source ID of the UE. In one example, the SSID-FR2 is encoded based on a serving temporary mobile subscriber identity (s-TMSI) assigned to the UE by a core network (e.g., an international mobile subscriber identity (IMSI)) of the UE. In one example, the SSID-FR2 is configured for the UE by a radio access network (RAN). In one example, the method includes enabling communication with another UE having an SSID-FR2 between 1 and 335.

In one example, the method includes generating a sidelink primary synchronization signal (S-PSS) based on a first or third value of three configured seed values, wherein the first seed value generates SSID-FR2 between 1 and 335 and the third seed value generates SSID-FR2 between 671 and 1007. In one example, the method includes enabling sidelink communication with another UE having an SSID-FR2 between 1 and 335 or 671 and 1007. In one example, the method includes encoding the SSID-FR2 based on a destination identifier (ID) assigned to the UE by a higher layer. In one example, the method includes encoding the SSID-FR2 using bits encoded in a demodulation reference signal (DMRS). In one example, the method includes encoding the SSID-FR2 using bits in a physical broadcast channel (PBCH) payload of the SSB.

FIG. 18 is a flow diagram outlining a method 1800 for performing sidelink synchronization and beamforming. The method 1800 may be performed by a UE as described in FIGS. 5, 7, 9, and 13. The method includes, at 1810, receiving, from a transmit (TX) UE a sidelink synchronization signal block (S-SSB) that encodes a synchronization source identifier (SSID) for frequency range 2 (FR2) based on a UE identifier (ID). The method includes, at 1820, performing beamforming based on the UE identifier.

In one example, the SSID-FR2 encodes a source identifier (ID) assigned to the TX UE by a higher layer. The source ID may be derived by the higher layer based on mod (SSID, 256). The SSID-FR2 value may be between 1 and 256 based on a source ID of the TX UE. In one example, the method includes enabling sidelink communication with another UE having an SSID-FR2 between 1 and 335. In one example, the SSID-FR2 encodes a serving temporary mobile subscriber identity (s-TMSI) assigned to the TX UE by a core network. In one example, the SSID-FR2 encodes an international mobile subscriber identity (IMSI) of the TX UE. In one example, the SSID-FR2 is configured for the TX UE by a radio access network (RAN).

In one example, the method includes determining a sidelink primary synchronization signal (S-PSS) of the S-SSB based on a first or third value of three configured seed values, wherein the first seed value corresponds to SSID-FR2 between 1 and 335 and the third seed value generates SSID-FR2 between 671 and 1007. In one example, the method includes enabling sidelink communication with another UE having an SSID-FR2 between 1 and 335 or 671 and 1007. In one example, the SSID-FR2 encodes a destination identifier (ID) assigned to the TX UE by a higher layer. In one example the SSID-FR2 includes bits encoded by a demodulation reference signal (DMRS). In one example, the SSID-FR2 includes bits encoded by bits in a physical broadcast channel (PBCH) payload of the SSB.

FIG. 19 is a flow diagram outlining a method 1900 for performing sidelink synchronization and beamforming. The method 1900 may be performed by a UE as described with reference to FIGS. 11 and 15. The method includes, at 1910, generating a sidelink synchronization signal block (S-SSB) that encodes a synchronization source identifier (SSID) that identifies a synchronization source of the UE. At 1920, m bits of the S-SSB are encoded based on a UE identifier. The S-SSB is transmitted to a receiving (RX) UE at 1930.

In one example, the m bits correspond to a DMRS or PBCH payload of the S-SSB. In one example, the method includes enabling sidelink communication with another UE that has a same SSID as the UE while not enabling sidelink communication with another UE that has a different SSID than the UE.

FIG. 20 is a flow diagram outlining a method 2000 for performing sidelink synchronization and beamforming. The method 2000 may be performed by a UE as described with reference to FIGS. 11 and 15. The method includes, at 2010, receiving a sidelink synchronization signal block (S-SSB) that encodes a synchronization source identifier (SSID) that identifies a synchronization source of the UE. At 2020, m bits of the S-SSB are decoded to determine a UE identifier. At 2030, the method includes performing beamforming based on the UE ID.

In one example, the m bits correspond to a DMRS or PBCH payload of the S-SSB. In one example, the method includes enabling sidelink communication with another UE that has a same SSID as the UE while not enabling sidelink communication with another UE that has a different SSID than the UE.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

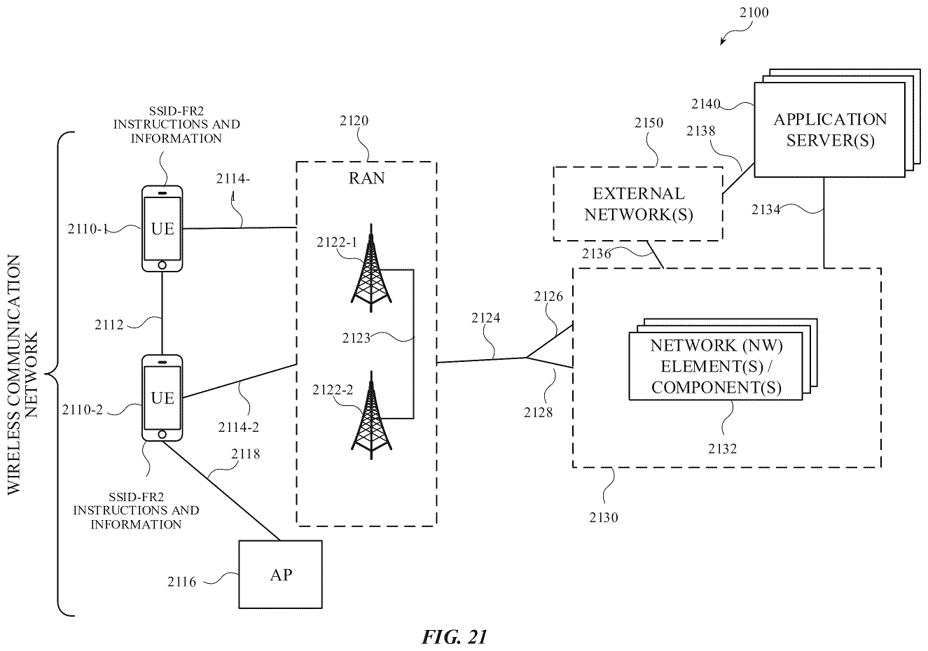

FIG. 21 is an example network 2100 according to one or more implementations described herein. Example network 2100 may include UEs 2110-1, 2110-2, etc. (referred to collectively as “UEs 2110” and individually as “UE 2110”), a radio access network (RAN) 2120, a core network (CN) 2130, application servers 2140, and external networks 2150.

The systems and devices of example network 2100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 2100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 2110 may include smartphones (e.g., handheld touchscreen mobile computing devices connectable to one or more wireless communication networks). Additionally, or alternatively, UEs 2110 may include other types of mobile or non-mobile computing devices capable of wireless communications, such as personal data assistants (PDAs), pagers, laptop computers, desktop computers, wireless handsets, watches etc. In some implementations, UEs 2110 may include internet of things (IOT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 2110 may use stored SSID-FR2 instructions and information for performing one or more of the solutions disclosed with reference to FIGS. 3-20 to communicate and establish a beamformed connection with one or more other UEs 2110 via one or more wireless channels 2112, each of which may comprise a physical communications interface/layer. The connection may include an M2M connection, MTC connection, D2D connection, SL connection, etc. The connection may involve a PC5 interface. In some implementations, UEs 2110 may be configured to discover one another, negotiate wireless resources between one another, and establish connections between one another, without intervention or communications involving RAN node 2122 or another type of network node. In some implementations, discovery, authentication, resource negotiation, registration, etc., may involve communications with RAN node 2122 or another type of network node.

UEs 2110 may use one or more wireless channels 2112 to communicate with one another. As described herein, UE 2110-1 may communicate with RAN node 2122 to request SL resources. RAN node 2122 may respond to the request by providing UE 2110 with a dynamic grant (DG) or configured grant (CG) regarding SL resources. A DG may involve a grant based on a grant request from UE 2110. A CG may involve a resource grant without a grant request and may be based on a type of service being provided (e.g., services that have strict timing or latency requirements). UE 2110 may perform a clear channel assessment (CCA) procedure based on the DG or CG, select SL resources based on the CCA procedure and the DG or CG; and communicate with another UE 2110 based on the SL resources. The UE 2110 may communicate with RAN node 2122 using a licensed frequency band and communicate with the other UE 2110 using an unlicensed frequency band.

UEs 2110 may communicate and establish a connection with (e.g., be communicatively coupled) with RAN 2120, which may involve one or more wireless channels 2114-1 and 2114-2, each of which may comprise a physical communications interface/layer.

As described herein, UE 2110 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 2110 may also, or alternatively, connect to access point (AP) 2116 via connection interface 2118, which may include an air interface enabling UE 2110 to communicatively couple with AP 2116. AP 2116 may comprise a wireless local area network (WLAN), WLAN node, WLAN termination point, etc. The connection 2118 may comprise a local wireless connection, such as a connection consistent with any IEEE 702.11 protocol, and AP 2116 may comprise a wireless fidelity (Wi-Fi®) router or other AP. While not explicitly depicted in FIG. 21, AP 2116 may be connected to another network (e.g., the Internet) without connecting to RAN 2120 or CN 2130.

RAN 2120 may include one or more RAN nodes 2122-1 and 2122-2 (referred to collectively as RAN nodes 2122, and individually as RAN node 2122) that enable channels 2114-1 and 2114-2 to be established between UEs 2110 and RAN 2120. RAN nodes 2122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 2122 may include a roadside unit (RSU), a transmission reception point (TRxP or TRP), and one or more other types of ground stations (e.g., terrestrial access points). In some scenarios, RAN node 2122 may be a dedicated physical device, such as a macrocell base station, and/or a low power (LP) base station for providing femtocells, picocells or the like having smaller coverage areas, smaller user capacity, or higher bandwidth compared to macrocells.

In some implementations, a downlink resource grid may be used for downlink transmissions from any of the RAN nodes 2122 to UEs 2110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated.

There are several different physical downlink channels that are conveyed using such resource blocks.

The RAN nodes 2122 may be configured to communicate with one another via interface 2123. In implementations where the system is an LTE system, interface 2123 may be an X2 interface. In NR systems, interface 2123 may be an Xn interface. The X2 interface may be defined between two or more RAN nodes 2122 (e.g., two or more eNBs/gNBs or a combination thereof) that connect to evolved packet core (EPC) or CN 2130, or between two eNBs connecting to an EPC.

As shown, RAN 2120 may be connected (e.g., communicatively coupled) to CN 2130. CN 2130 may comprise a plurality of network elements 2132, which are configured to offer various data and telecommunications services to customers/subscribers (e.g., users of UEs 2110) who are connected to the CN 2130 via the RAN 2120. In some implementations, CN 2130 may include an evolved packet core (EPC), a 5G CN, and/or one or more additional or alternative types of CNs. The components of the CN 2130 may be implemented in one physical node or separate physical nodes including components to read and execute instructions from a machine-readable or computer-readable medium (e.g., a non-transitory machine-readable storage medium

As shown, CN 2130, application servers 2140, and external networks 2150 may be connected to one another via interfaces 2134, 2136, and 2138, which may include IP network interfaces.

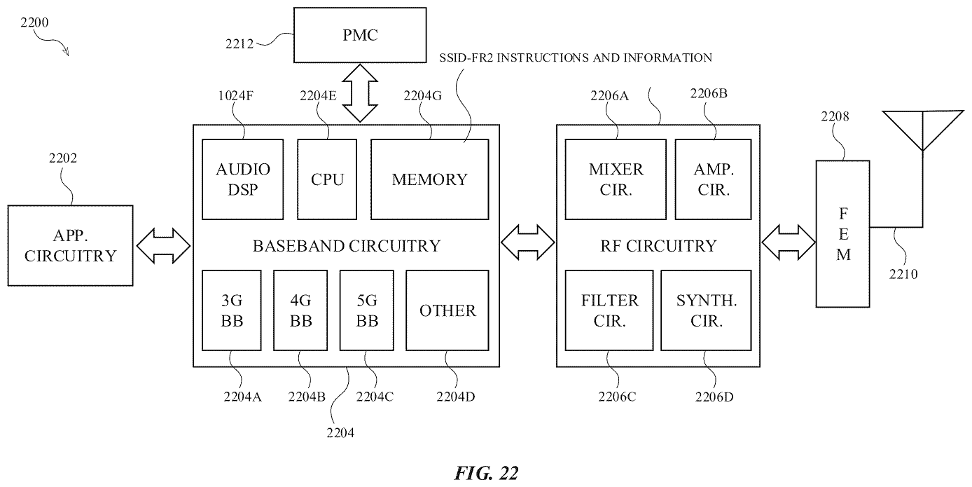

FIG. 22 is a diagram of an example of components of a network device according to one or more implementations described herein. In some implementations, the device 2200 can include application circuitry 2202, baseband circuitry 2204, RF circuitry 2206, front-end module (FEM) circuitry 2208, one or more antennas 2210, and power management circuitry (PMC) 2212 coupled together at least as shown. The components of the illustrated device 2200 can be included in a UE or a RAN node. In some implementations, the device 2200 can include fewer elements (e.g., a RAN node may not utilize application circuitry 2202, and instead include a processor/controller to process IP data received from a CN or an Evolved Packet Core (EPC)). In some implementations, the device 2200 can include additional elements such as, for example, memory/storage, display, camera, sensor (including one or more temperature sensors, such as a single temperature sensor, a plurality of temperature sensors at different locations in device 2200, etc.), or input/output (I/O) interface. In other implementations, the components described below can be included in more than one device (e.g., said circuitries can be separately included in more than one device for Cloud-RAN (C-RAN) implementations).

The application circuitry 2202 can include one or more application processors. For example, the application circuitry 2202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 2200. In some implementations, processors of application circuitry 2202 can process IP data packets received from an EPC.

The baseband circuitry 2204 can include circuitry such as, but not limited to, one or more single-core or multi-core processors. The baseband circuitry 2204 can include one or more baseband processors or control logic to process baseband signals received from a receive signal path of the RF circuitry 2206 and to generate baseband signals for a transmit signal path of the RF circuitry 2206. Baseband circuity 2204 can interface with the application circuitry 2202 for generation and processing of the baseband signals and for controlling operations of the RF circuitry 2206. For example, in some implementations, the baseband circuitry 2204 can include a 3G baseband processor 2204A, a 4G baseband processor 2204B, a 5G baseband processor 2204C, or other baseband processor(s) 2204D for other existing generations, generations in development or to be developed in the future (e.g., 5G, 6G, etc.).

The baseband circuitry 2204 (e.g., one or more of baseband processors 2204A-D) can handle various radio control functions that enable communication with one or more radio networks via the RF circuitry 2206. In other implementations, some or all of the functionality of baseband processors 2204A-D can be included in modules stored in the memory 2204G and executed via a Central Processing Unit (CPU) 2204E. In some implementations, the baseband circuitry 2204 can include one or more audio digital signal processor(s) (DSP) 2204F.

In some implementations, memory 2204G may receive and/or store sidelink beamforming instructions and information that cause the device 2200 to act as a TX UE and/or RX UE as disclosed with reference to FIGS. 3-20.

RF circuitry 2206 can enable communication with wireless networks using modulated electromagnetic radiation through a non-solid medium. In various implementations, the RF circuitry 2206 can include switches, filters, amplifiers, etc. to facilitate the communication with the wireless network. RF circuitry 2206 can include a receive signal path which can include circuitry to down-convert RF signals received from the FEM circuitry 2208 and provide baseband signals to the baseband circuitry 2204. RF circuitry 2206 can also include a transmit signal path which can include circuitry to up-convert baseband signals provided by the baseband circuitry 2204 and provide RF output signals to the FEM circuitry 2208 for transmission.

In some implementations, the receive signal path of the RF circuitry 2206 can include mixer circuitry 2206A, amplifier circuitry 2206B and filter circuitry 2206C. In some implementations, the transmit signal path of the RF circuitry 2206 can include filter circuitry 2206C and mixer circuitry 2206A. RF circuitry 2206 can also include synthesizer circuitry 2206D for synthesizing a frequency for use by the mixer circuitry 2206A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

### EXAMPLES

Example 1 is a baseband processor configured to, when executing instructions stored in the memory, cause the UE to generate a sidelink synchronization signal block (S-SSB) that encodes a synchronization source identifier (SSID) for frequency range 2 (FR2) (SSID-FR2) based on a UE identifier (ID); and transmit the S-SSB to a receiving (RX) UE.

Example 2 includes the subject matter of example 1, including or omitting optional elements, wherein the baseband processor is configured to encode the SSID-FR2 based on a source identifier (ID) assigned to the UE by a higher layer.

Example 3 includes the subject matter of any of examples 1-2 including or omitting optional elements, wherein the baseband processor is configured to enable sidelink communication with another UE having an SSID-FR2 between 1 and 335.

Example 4 includes the subject matter of any of examples 1-3, including or omitting optional elements, wherein the baseband processor is configured to encode the SSID-FR2 based on a serving temporary mobile subscriber identity (s-TMSI) assigned to the UE by a core network.

Example 5 includes the subject matter of any of examples 1-4, including or omitting optional elements, wherein the baseband processor is configured to encode the SSID-FR2 based on an international mobile subscriber identity (IMSI) of the UE.

Example 6 includes the subject matter of any of examples 1-5, including or omitting optional elements, wherein the SSID-FR2 is configured for the UE by a radio access network (RAN).

Example 7 includes the subject matter of any of examples 1-6, including or omitting optional elements, wherein the baseband processor is configured to generate a sidelink primary synchronization signal (S-PSS) based on a first or third value of three configured seed values, wherein the first seed value generates SSID-FR2 between 1 and 335 and the third seed value generates SSID-FR2 between 671 and 1007.

Example 8 includes the subject matter of any of examples 1-7, including or omitting optional elements, wherein the baseband processor is configured to enable sidelink communication with another UE having an SSID-FR2 between 1 and 335 or 671 and 1007.

Example 9 includes the subject matter of any of examples 1-8, including or omitting optional elements, wherein the baseband processor is configured to encode the SSID-FR2 based on a destination identifier (ID) assigned to the UE by a higher layer.

Example 10 includes the subject matter of any of examples 1-9, including or omitting optional elements, wherein the baseband processor is configured to encode the SSID-FR2 using bits encoded in a demodulation reference signal (DMRS).

Example 11 includes the subject matter of any of examples 1-10, including or omitting optional elements, wherein the baseband processor is configured to encode the SSID-FR2 using bits in a physical broadcast channel (PBCH) payload of the SSB.

Example 12 is a baseband processor configured to, when executing instructions stored in the memory, cause the UE to receive, from a transmit (TX) UE a sidelink synchronization signal block (S-SSB) that encodes a synchronization source identifier (SSID) for frequency range 2 (FR2) based on a UE identifier (ID); and perform beamforming based on the UE identifier.

Example 13 includes the subject matter of example 12, including or omitting optional elements, wherein the SSID-FR2 encodes a source identifier (ID) assigned to the TX UE by a higher layer.

Example 14 includes the subject matter of any of examples 12-13, including or omitting optional elements, wherein the baseband processor is configured to enable sidelink communication with another UE having an SSID-FR2 between 1 and 335.

Example 15 includes the subject matter of any of examples 12-14, including or omitting optional elements, wherein the SSID-FR2 encodes a serving temporary mobile subscriber identity (s-TMSI) assigned to the TX UE by a core network.

Example 16 includes the subject matter of any of examples 12-15, including or omitting optional elements, wherein the SSID-FR2 encodes an international mobile subscriber identity (IMSI) of the TX UE.

Example 17 includes the subject matter of any of examples 12-16, including or omitting optional elements, wherein the SSID-FR2 is configured for the TX UE by a radio access network (RAN).

Example 18 includes the subject matter of any of examples 12-17, including or omitting optional elements, wherein the baseband processor is configured to determine a sidelink primary synchronization signal (S-PSS) of the S-SSB based on a first or third value of three configured seed values, wherein the first seed value corresponds to SSID-FR2 between 1 and 335 and the third seed value generates SSID-FR2 between 671 and 1007.

Example 19 includes the subject matter of any of examples 12-18, including or omitting optional elements, wherein the baseband processor is configured to enable sidelink communication with another UE having an SSID-FR2 between 1 and 335 or 671 and 1007.

Example 20 includes the subject matter of any of examples 12-19, including or omitting optional elements, wherein the SSID-FR2 encodes a destination identifier (ID) assigned to the TX UE by a higher layer.

Example 21 includes the subject matter of any of examples 12-20, including or omitting optional elements, wherein the SSID-FR2 includes bits encoded by a demodulation reference signal (DMRS).

Example 22 includes the subject matter of any of examples 12-21, including or omitting optional elements, wherein the SSID-FR2 includes bits encoded by bits in a physical broadcast channel (PBCH) payload of the SSB.

Example 23 is an apparatus for a user equipment (UE), including a memory and a baseband processor. The baseband processor is configured to, when executing instructions stored in the memory, generate a sidelink synchronization signal block (S-SSB) that encodes a synchronization source identifier (SSID) that identifies a synchronization source of the UE; encode m bits of the S-SSB based on a UE identifier; and transmit the S-SSB to a receiving (RX) UE.

Example 24 includes the subject matter of example 23, including or omitting optional elements, wherein the m bits correspond to a DMRS or PBCH payload of the SSB.

Example 25 includes the subject matter of any of examples 23-24, including or omitting optional elements, wherein the baseband processor is configured to enable sidelink communication with another UE that has a same SSID as the UE while not enabling sidelink communication with another UE that has a different SSID than the UE.

Example 26 is an apparatus for a user equipment (UE), including a memory and a baseband processor. The baseband processor is configured to, when executing instructions stored in the memory, receive a sidelink synchronization signal block (S-SSB) that encodes a synchronization source identifier (SSID) that identifies a synchronization source of the UE; decode m bits of the S-SSB based on a UE identifier; and perform beamforming based on the UE identifier.

Example 27 includes the subject matter of example 26, including or omitting optional elements, wherein the m bits correspond to a DMRS or PBCH payload of the SSB.

Example 28 includes the subject matter of any of examples 26-27, including or omitting optional elements, wherein the baseband processor is configured to enable sidelink communication with another UE that has a same SSID as the UE while not enabling sidelink communication with another UE that has a different SSID than the UE.

Example 29 is a user equipment (UE) including the apparatus of any of claims 1-28.

Example 30 is a method including operations performed by the baseband processor of any of claims 1-28.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, configured to:
generate a sidelink synchronization signal block (S-SSB) that encodes a synchronization source identifier (SSID) for frequency range 2 (FR2) (SSID-FR2) based on a UE identifier (ID); and
transmit cause transmission of the S-SSB to a receiving (RX) UE.

2. The baseband processor of claim 1, configured to encode the SSID-FR2 based on a source identifier (ID) assigned to the UE by a higher layer.

3. The baseband processor of claim 1, configured to encode the SSID-FR2 based on a serving temporary mobile subscriber identity (s-TMSI) assigned to the UE by a core network or an international mobile subscriber identity (IMSI) of the UE.

4. The baseband processor of claim 1, wherein the SSID-FR2 is configured for the UE by a radio access network (RAN).

5. The baseband processor of claim 1, configured to generate a sidelink primary synchronization signal (S-PSS) based on a first or third value of three configured seed values, wherein the first seed value generates SSID-FR2 between 1 and 335 and the third seed value generates SSID-FR2 between 671 and 1007.

6. The baseband processor of claim 1, configured to encode the SSID-FR2 based on a destination identifier (ID) assigned to the UE by a higher layer.

7. The baseband processor of claim 1, configured to encode the SSID-FR2 using bits encoded in a demodulation reference signal (DMRS).

8. The baseband processor of claim 1, configured to encode the SSID-FR2 using bits in a physical broadcast channel (PBCH) payload of the SSB.

9. A user equipment (UE), comprising:
a memory; and
a processor coupled to the memory, the processor configured to, when executing instructions stored in the memory, cause the UE to:
receive, from a transmit (TX) UE a sidelink synchronization signal block (S-SSB) that encodes a synchronization source identifier (SSID) for frequency range 2 (FR2) based on a UE identifier (ID); and
perform beamforming based on the UE identifier.

10. The UE of claim 9, wherein the SSID-FR2 encodes a source identifier (ID) assigned to the TX UE by a higher layer.

11. The UE of claim 9, wherein the SSID-FR2 encodes a serving temporary mobile subscriber identity (s-TMSI) assigned to the TX UE by a core network or an international mobile subscriber identity (IMSI) of the TX UE.

12. The UE of claim 9, wherein the SSID-FR2 is configured for the TX UE by a radio access network (RAN).

13. The UE of claim 9, wherein the processor is configured to determine a sidelink primary synchronization signal (S-PSS) of the S-SSB based on a first or third value of three configured seed values, wherein the first seed value corresponds to SSID-FR2 between 1 and 335 and the third seed value generates SSID-FR2 between 671 and 1007.

14. The UE of claim 13, wherein the processor is configured to enable sidelink communication with another UE having an SSID-FR2 between 1 and 335 or 671 and 1007.

15. The UE of claim 9, wherein the SSID-FR2 encodes a destination identifier (ID) assigned to the TX UE by a higher layer.

16. The UE of claim 9, wherein the SSID-FR2 includes bits encoded by a demodulation reference signal (DMRS).

17. The UE of claim 9, wherein the SSID-FR2 includes bits encoded by bits in a physical broadcast channel (PBCH) payload of the SSB.

18. A user equipment (UE), comprising:
a memory; and
a processor configured to, when executing instructions stored in the memory, cause the UE to:
generate a sidelink synchronization signal block (S-SSB) that encodes a synchronization source identifier (SSID) that identifies a synchronization source of the UE;
encode m bits of the S-SSB based on a UE identifier; and
transmit the S-SSB to a receiving (RX) UE.

19. The UE of claim 18, wherein the m bits correspond to a DMRS or PBCH payload of the SSB.

20. The UE of claim 18, wherein the baseband processor is configured to enable sidelink communication with another UE that has a same SSID as the UE while not enabling sidelink communication with another UE that has a different SSID than the UE.
